(19) United States
(12) Patent Application Publication
(10) Pub. No.: US 2025/0115018 A1
(43) Pub. Date: Apr. 10, 2025

(54) COMPOSITE MATERIAL FOR ELASTOMERIC PRODUCTS, IN PARTICULAR VEHICLE TYRES, AND METHOD FOR MANUFACTURING SAME

(71) Applicant: Continental Reifen Deutschland GmbH, Hannover (DE)

(72) Inventors: Thomas Kramer, Herford (DE); Nermeen Nabih, Hannover (DE); Michael Schunack, Hannover (DE); Wolfgang Reese, Peine (DE); Cornelia Schmaunz-Hirsch, Wunstorf (DE); Imme Kretschmer, Hannover (DE)

(73) Assignee: Continental Reifen Deutschland GmbH, Hannover (DE)

(21) Appl. No.: 18/836,013

(22) PCT Filed: Feb. 17, 2022
(86) PCT No.: PCT/EP2022/053960

§ 371 Date: Aug. 6, 2024

(51) Int. Cl. B29D 30/40; B29D 30/38; D01F 6/62; D06M 15/693

(52) U.S. Cl. CPC B29D 30/40; D01F 6/62; D06M 15/693; B29D 2030/383

(57) ABSTRACT

A process for producing a vulcanizable composite material, including the steps of: a) producing or providing a textile strength member, b) treating the textile strength member with an aqueous dispersion for adhesive activation of the textile strength member and to obtain an adhesion-activated textile strength member, and c) introducing the adhesion-activated textile strength member into a crosslinkable rubberization mixture to obtain the vulcanizable composite material, wherein the aqueous dispersion is essentially free of free resorcinol and resorcinol precondensates, especially resorcinol-formaldehyde precondensates, and is free of free formaldehyde and formaldehyde-releasing substances, wherein the textile strength member in step a) has filaments, wherein the filaments contain one or more materials selected from the group consisting of a1) recycled polymers and a2) biobased polymers.

The present application is a National Stage Application under 35 U.S.C. § 371 of International Patent Application No. PCT/EP2022/053960 filed on Feb. 17, 2022, the disclosure of which is herein incorporated by reference in its entirety.

The invention relates to a process for producing a vulcanizable composite material and to a process based thereon for producing a vulcanized composite material or an elastomeric product, and to a corresponding vulcanizable composite material and to a vulcanized composite material producible therefrom or a corresponding elastomeric product.

It is known that vehicle tires, in various components, have textile strength members for reinforcement. In many cases, other industrial rubber articles too, such as belts (including transmission belts) and hoses, have strength members. The strength members here are typically surrounded by at least one rubber mixture which is also referred to as rubberization mixture or, in the vulcanized state, as rubberization.

It is regularly a problem that the strength members and the surrounding rubberization generally have different mechanical properties, especially different strengths. Particularly in the case of sustained mechanical and dynamic stress, as occurs in traveling operation of the vehicle tire, there is therefore a need for sufficient adhesion between the strength members and the surrounding rubberization in order nevertheless to be able to assure adequate bond strength.

The prior art discloses activation of the strength members prior to rubberization for adequate adhesion (called activation of adhesion or adhesive activation), typically by using what are called RFL (resorcinol-formaldehyde latex) dips that can be applied by means of a dip bath, for example.

The prior art also proposes aqueous dispersions for activation of adhesion that are essentially free of free resorcinol and resorcinol precondensates, especially resorcinol-formaldehyde precondensates, and are free of free formaldehyde and formaldehyde-releasing substances. Dispersions of this kind are disclosed, for example, in WO 2019/015792 A1, and also EP 3702521 A1, EP 3702522 A1 and EP 3702523 A1. With the dispersions described, the production of elastomeric products having strength members, in particular vehicle tires, becomes more environmentally benign and less harmful to health than with dispersions containing free resorcinol etc.

At the same time, compared to the use of dispersions as described in WO 2015/188939 A1, WO 2014/175844 A2 and WO 2014/091376 A1, improved binding between strength members and rubberization and improved processibility are achieved, especially storage stability of the treated strength members.

As well as the aspects of relevance to health, the environment and service life that have been described, in the field of production of vehicle tires, there is also a constantly growing need to make the production process more sustainable and environmentally benign with regard to the selection of the materials.

The materials used in the strength members are usually selected according to their physicochemical properties and in the light of the respective profile of requirements.

In order to increase the sustainability of manufacture of corresponding composite materials—comprising adhesion-activated strength members and surrounding rubberization- and to reduce dependence on fossil raw materials, efforts have been made in the prior art to replace petrochemically produced strength members with natural fibers. However, with regard to quality and reproducibility of the composite materials producible thereby, this is regularly perceived as being disadvantageous, especially because natural fibers in many cases do not have the necessary physicochemical properties, for example with regard to shrinkage characteristics. Moreover, some natural fibers have further properties that make them less suitable for use in composite materials in pneumatic vehicle tires, one example of which is the known moisture sensitivity of the material rayon. Furthermore, natural fibers are regularly available solely as staple fibers and not as continuous fibers.

It is an object of the present invention to provide a process for producing a composite material that can be operated in a more sustainable manner and with which dependence on fossil raw materials is reduced. At the same time, the process shall be as benign to health and the environment as possible. The composite materials produced by the process are additionally to have optimized service life, such that they meet the high mechanical demands in their typical use. The composite materials are thus to have excellent properties in spite of high sustainability, such that they can be used to produce high-performance vulcanized elastomeric products, especially vehicle tires.

Moreover, it is an object of the present invention to provide a process for producing an elastomeric product, especially a vehicle tire, and a corresponding elastomeric product, especially a vehicle tire. It is an object of the present invention for the corresponding vehicle tires to have a more sustainable composition and make a contribution to safety of travel.

The aforementioned objects are achieved by means of the subject matter of the invention as defined in the claims. Preferred configurations of the invention will be apparent from the further claims and from the details that follow.

Embodiments that are referred to below as preferred are combined with features of other embodiments that are referred to as preferred in particularly preferred embodiments. Most particularly preferred are therefore combinations of two or more of the embodiments that are referred to below as particularly preferred. Likewise preferred are embodiments in which a feature of one embodiment that is referred to as preferred to a certain extent is combined with one or more further features of other embodiments that are referred to as preferred to a certain extent. Features of preferred vulcanizable composite materials, vulcanized composite materials, elastomeric products and vehicle tires will also be apparent from the features of preferred processes.

The invention relates to a process for producing a vulcanizable composite material, comprising the steps of:
a) producing or providing a textile strength member,
b) treating the textile strength member with an aqueous dispersion for adhesive activation of the textile strength member and to obtain an adhesion-activated textile strength member, and
c) introducing the adhesion-activated textile strength member into a crosslinkable rubberization mixture to obtain the vulcanizable composite material, wherein the aqueous dispersion is essentially free of free resorcinol and resorcinol precondensates, especially resorcinol-formaldehyde precondensates, and is free of free formaldehyde and formaldehyde-releasing substances,
wherein the textile strength member in step a) has filaments, wherein the filaments contain one or more materials selected from the group consisting of
a1) recycled polymers and a2) biobased polymers, wherein the recycled and biobased polymers are preferably selected from the group consisting of
polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12 and
aramids such as, in particular, m-aramid and p-aramid.

It has been found that, surprisingly, the process of the invention can be operated in a more sustainable manner through the combination of the selection of the aqueous dispersion for activation of adhesion and of materials mentioned, and dependence on fossil raw materials is reduced. At the same time, the process is benign to health and the environment. Moreover, the composite materials produced surprisingly have optimized service life in spite of high sustainability.

The selection of the materials of the filaments of the strength member makes it possible to significantly reduce dependence on fossil raw materials, especially on mineral oil, and to produce a particularly important component for the manufacture of vehicle tires by a sustainable process that results in particularly environmentally benign products.

As a result of the high demands on the physicochemical properties of materials used in strength members, this finding is surprising since it was not foreseeable that composite materials produced by corresponding processes could indeed be suitable for use in modern vehicle tires and still have excellent properties comparable to those of composite materials equipped with petrochemically produced strength members.

The expression “essentially free of”, in accordance with the understanding of the person skilled in the art, in the context of the present invention, should be understood to mean that the corresponding substances may be present only in amounts that do not significantly influence the essential properties of the composition claimed. For example, the amount of these substances must not go beyond trace amounts that result from a contamination. Typically, in the aqueous dispersion for use in accordance with the invention, there should be not more than 0.1% by weight (dry weight), based on the total weight of aqueous dispersion, of each of the components specified, for instance resorcinol, resorcinol precondensates, formaldehyde and formaldehyde-releasing substances, i.e. 0.1% by weight is the maximum amount for each of the above components. The content of all these components in the aqueous dispersion is preferably 0% by weight.

Suitable aqueous dispersions for activation of adhesion are especially those systems that are disclosed, for example, in WO 2019/015792 A1 and in EP 3702521 A1, EP 3702522 A1 and EP 3702523 A1.

Preference is fundamentally given in this respect to a process of the invention wherein the aqueous dispersion comprises:
(w1) at least one rubber latex, provided that said rubber latex is not a polyisoprene rubber latex (including synthetic and natural polyisoprene rubber latex), and
(w2) at least one protected isocyanate, and
(w3) at least one filler and/or at least one polymer having carboxylic acid-functional groups and/or at least one polyisoprene rubber (including synthetic and natural polyisoprene rubber latex) and/or at least one wax.

An example of useful rubber latex is VP latex. VP latex is known to those skilled in the art. “VP” stands for “vinylpyridine”, and known VP latices may also include additional monomers. A preferred example of a VP latex is a vinylpyridine latex which typically comprises 15% vinylpyridine, 15% styrene and 70% butadiene monomers. As well as the VP latex, the aqueous dispersion may comprise one or more additional latices, for instance a styrene-butadiene latex (SVR) and natural latex (NR).

For isoprene rubber, preference is given to the use of natural latex with a high ammonia content that comes from the “Hevea Brasiliensis” tree.

Suitable polyisocyanate compounds as a constituent of bath/dips for textile strength members are known in principle to those skilled in the art. The polyisocyanate compound may be blocked with another compound or be in the form of a dimer or higher homolog, i.e. in “self-blocked” form. Blocked polyisocyanates are, for example and with preference, obtained by blocking free isocyanates with at least one substance selected from the group consisting of phenol, thiophenol, chlorophenol, cresol, resorcinol, p-sec-butylphenol, p-tert-butylphenol, p-sec-amylphenol, p-octylphenol, p-nonylphenol, tert-butyl alcohol, diphenylamine, dimethylaniline, phthalimide, 8-valerolactam, ¿-caprolactam, dialkyl malonate, acetylacetone, alkyl acetoacetate, acetoxime, methyl ethyl ketoxime, 3,5-dimethylpyrazole, cyclohexanone oxime, 3-hydroxypyridine and acidic sodium sulfite. It is preferable in the context of the present invention for the polyisocyanate compound to comprise units selected from the group consisting of tetramethylene diisocyanate, hexamethylene diisocyanate, diphenylmethane 4,4′-diisocyanate, octamethylene diisocyanate, decamethylene diisocyanate, dodecamethylene diisocyanate, aromatic diisocyanates comprising toluene 2,4- or 2,6-diisocyanate, tetramethylxylylene diisocyanate, p-xylene diisocyanate, 2,4′- or 4,4′-diisocyanatodiphenylmethane, phenyl 1,3-or 1,4-diisocyanate.

The polycarboxylic acid is based, for example, to an extent of 10 to 100 mol %, preferably to an extent of 30 to 100 mol %, more preferably to an extent of 50 to 100 mol %, even more preferably to an extent of 70 to 100 mol %, especially preferably to an extent of 90 to 100 mol %, on monomers containing carboxylic acid groups. In a particularly advantageous embodiment of the invention, the polycarboxylic acid is based to an extent of 100 mol % on monomers containing carboxylic acid groups, without ruling out further functional groups. Preferably, the polycarboxylic acid has a weight-average molecular weight Mw by GPC of 1000 to 500 000 g/mol, preferably 3000 to 100 000 g/mol. Preferably, the polycarboxylic acid is based on acrylic acid, methacrylic acid, itaconic acid, crotonic acid, cinnamic acid and/or maleic acid monomers. In a preferred embodiment, the polycarboxylic acid (based on acrylic acid monomers) is an acrylic resin.

Suitable epoxy compounds as a constituent of corresponding aqueous dispersions are known in principle to the person skilled in the art. It is preferable in the context of the present invention for the epoxy compound to be selected from the group consisting of glycidyl-based glycerol, sorbitol-based epoxy compounds, phenol-based novolak epoxy compounds and cresol-based novolak epoxy compounds. A particularly suitable example of an epoxy compound is a glycerol-based polyglycidyl ether, for example Denacol™ EX-313, which is described inter alia in DE 69722388 T2.

Possible waxes as a constituent of corresponding aqueous dispersions are known in principle to the person skilled in the art. Preferred examples are paraffinic waxes, microcrystalline waxes, synthetic waxes and waxes from natural sources, for example beeswax, also including combinations of two or more waxes.

Particularly suitable fillers for the aqueous dispersion are water-dispersible inorganic fillers. Particular preference is given to amorphous silicon dioxide (especially precipitated silica) and silicates having a BET surface area (to ISO 9277:2010) of 30 to 450 m²/g, preferably of 120 to 410 m²/g.

The aqueous dispersion preferably has a pH of 5 to 11, preferably of 7 to 11, which can appropriately be established with a base. The base is preferably a volatile base which evaporates, or the constituents of which evaporate, during the process. In a particularly advantageous embodiment of the invention, the base is ammonium hydroxide, i.e. an aqueous solution of ammonia.

In the light of the above details, preference is given to a process of the invention wherein the aqueous dispersion comprises:
(x1) at least one rubber latex, preferably in a proportion by mass based on the dry weight of the aqueous dispersion of 4% to 60%, and
(x2) at least one protected isocyanate, preferably in a proportion by mass based on the dry weight of the aqueous dispersion of 0.1% to 10%.

Preference is additionally given to a process of the invention wherein the aqueous dispersion comprises:
(y1) at least one compound containing an epoxy group, preferably in a proportion by mass based on the dry weight of the aqueous dispersion of up to 6%, and/or
(y2) at least one polymer having carboxylic acid-functional groups, preferably in a proportion by mass based on the dry weight of the aqueous dispersion of up to 15%.

Particular preference is given to a process of the invention wherein the aqueous dispersion comprises one of the following components:
(z1) at least one filler, preferably in a proportion by mass based on the dry weight of the aqueous dispersion of 0.02% to 20%, preferably with the proviso that the aqueous dispersion does not include any polymer having carboxylic acid-functional groups,
or
(z2) at least one polyisoprene rubber latex, preferably in a proportion by mass based on the dry weight of the aqueous dispersion of 1% to 20%, preferably with the proviso that the aqueous dispersion includes at least one rubber latex which is not a polyisoprene rubber latex,
or
(z3) at least one wax, preferably in a proportion by mass based on the dry weight of the aqueous dispersion of 0.3% to 30%.

Among the possible aqueous dispersions for activation of adhesion, three specific embodiments are particularly suitable.

To wit, preference is given to a process of the invention wherein the aqueous dispersion comprises:
(h1) at least one rubber latex, in a proportion by mass based on the dry weight of the aqueous dispersion of 4% to 50%, preferably of 4.5% to 25%,
(h2) at least one protected isocyanate, in a proportion by mass based on the dry weight of the aqueous dispersion of 0.1% to 4.5%, preferably of 0.2% to 4%,
(h3) at least one filler, in a proportion by mass based on the dry weight of the aqueous dispersion of 0.02% to 20%, preferably of 0.3% to 15%.

Preference is alternatively given to a process of the invention wherein the aqueous dispersion comprises:
(i1) at least one rubber latex, in a proportion by mass based on the dry weight of the aqueous dispersion of 4% to 50%, preferably of 4.5% to 25%,
(i2) at least one protected isocyanate, in a proportion by mass based on the dry weight of the aqueous dispersion of 0.1% to 10%, preferably 0.2% to 4.5%,
(i3) at least one wax, in a proportion by mass based on the dry weight of the aqueous dispersion of 0.3% to 30%, preferably of 0.5% to 15%.

Preference is alternatively in turn given to a process of the invention wherein the aqueous dispersion comprises:
(j1) at least one rubber latex, in a proportion by mass based on the dry weight of the aqueous dispersion of 4% to 40%, preferably of 4.5% to 20%, where the rubber latex is not a polyisoprene rubber latex,
(j2) at least one protected isocyanate, in a proportion by mass based on the dry weight of the aqueous dispersion of 0.1% to 10%, preferably 0.2% to 4.5%,
(j3) at least one polyisoprene rubber latex, preferably in a proportion by mass based on the dry weight of the aqueous dispersion of 1% to 20%, preferably 2% to 15%.

With all the described executions relating to the aqueous dispersion, especially those identified at least as preferred, it has surprisingly been possible in combination with the selection of the sustainable materials of the textile strength member to provide a process which is benign to the environment and health, by which more sustainable composite materials that have simultaneously been optimized in terms of properties are produced.

Even though a different application method is possible, the aqueous dispersion is preferably applied as a dip. Preference is therefore given to a process of the invention wherein the treatment in step b) comprises dipping the textile strength member into the aqueous dispersion, wherein the treatment preferably additionally comprises hot stretching of the dipped textile strength members.

As already set out, the textile strength member produced or provided in step
a) has filaments, wherein the filaments contain one or more materials selected from the group consisting of
a1) recycled polymers and a2) biobased polymers, wherein the recycled and biobased polymers are preferably selected from the group consisting of
polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12 and
aramids such as, in particular, m-aramid and p-aramid.

It has been found that, surprisingly, the process of the invention, through the combination of the selection of the aqueous dispersion for activation of adhesion and of materials mentioned, especially with selection of the polymers from the group consisting of
polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12 and
aramids such as, in particular, m-aramid and p-aramid, is more sustainable and simultaneously more benign to health and the environment, and the composite materials thus produced have optimized service life.

The textile strength member may in principle also have different filaments that differ with regard to the material, wherein preferably all filaments contain one or more materials selected from the abovementioned group.

In addition, a filament may contain exactly one of the materials mentioned or two or more of the materials mentioned, preferably in a homogeneous mixture.

In addition, a filament may contain one or more of the materials mentioned and simultaneously at least one further material such as, in particular, physically mineral oil-based polyester such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12 and
aramids such as, in particular, m-aramid and p-aramid.

In advantageous embodiments of the invention, however, the filaments of the textile strength member do not contain any other materials, especially any other physically mineral oil-based materials.

Preferably, the filaments of the textile strength member are in the form of a multifilament yarn. In the context of the present invention, the term “yarn” is also used for “multifilament yarn”.

In the process of the invention for production of a vulcanizable composite material, the textile strength members are thus preferably produced or provided in the form of one or more yarns.

Preference is given to a process of the invention wherein the one or more yarns each have a linear yarn density in the range from 100 to 5000 dtex.

Particularly preferred values for the linear density of a yarn are especially guided by the type of elastomeric product and the resulting desired profile of properties.

It has been found to be advantageous in the context of the present invention when the linear yarn density for the use of the composite material produced in bicycle tires is from 100 to 1500 dtex, in car and van tires from 300 to 4000 dtex, and, for example, in truck and agricultural tires from 500 to 5000 dtex.

Preference is likewise given to a process of the invention wherein the one or more yarns have each been twisted at 100 to 600 T/m. In this case too, particularly preferred values for the twisting of a yarn are especially guided by the type of elastomeric product and the resulting desired profile of properties.

Moreover, the person skilled in the art will know how to match linear yarn density and twisting to one another appropriately.

The one or more yarns are preferably twisted to form a reinforcement cord. In the case of one yarn, the result is an x1 cord, whereas, in the case of two intertwisted yarns, for example, an x2 cord is obtained.

In the case of an x2 cord, the two yarns are preferably first twisted individually in one direction (for example in S direction) and then end-twisted together in the opposite direction (in the same example, in Z direction) with about the same number of turns to give the cord. It is immaterial here whether twisting is effected first in S or in Z direction. Production is especially effected by means of ring twisters or cabling machines.

Preference is given here to a process of the invention wherein the one or more yarns, in the case of an x2 cord or x3 cord, each have a twist factor in the range from 100 to 300, preferably in the range from 150 to 250.

It is preferable in the case of an x1 cord that the yarn has a twist factor of 20 to 100, more preferably 20 to 60, most preferably from 30 to 50.

The twist factor a is a parameter known to the person skilled in the art and is calculated from the twist level in T/m (turns per meter) and the linear density in tex:

$$α = T / m \sqrt{\frac{t e x}{1000}}$$

In the process of the invention for production of a vulcanizable composite material, the textile strength members are thus preferably produced or provided in the form of a reinforcement cord composed of one or more yarns.

Preference is additionally given to a process of the invention wherein the reinforcement cord comprises two or more yarns, wherein the reinforcement cord preferably has an overall linear density in the range from 200 to 10 000 dtex.

Especially for the production of composite materials for use as belt bandages, carcass plies, bead reinforcers and belt plies of vehicle tires, preference is given to processes of the invention in which all the yarns are executed as elucidated above.

The expression “recycled polymer” in the context of the present invention means a polymer that has been obtained by at least one recycling process.

The recycling process may be any of the recycling processes known to the person skilled in the art, such as, in particular, chemical and/or mechanical recycling.

Mechanical recycling processes in the context of the present invention also include thermal treatments such as, in particular, remelting.

Chemical recycling in the context of the present invention is any kind of chemical processing of wastes and subsequent recovery of products or precursor materials therefrom. This can also mean complete chemical degeneration to molecules from which the physical source, i.e. the chemical nature of the waste, is no longer immediately apparent, and subsequent synthesis from these molecules to the extent of polymers that are then used in the process of the invention as recycled polymer in the textile strength member.

In addition, it is also possible to recycle industrial yarn wastes and use them as material of the textile strength member in step a), such as, in particular, in the case of PET and PA 6.6.

In this context, depending on the nature and similarity of the yarn wastes to the materials required, chemical and/or mechanical recycling is viable.

The expression “biobased polymer” in the context of the present invention means a polymer which, in physical terms, is formed entirely or at least partly from monomers that have been obtained from biomasses.

The polymer may have been produced entirely from monomers from biomasses.

As a result, the process of the invention and the composite materials of the invention that have been produced thereby and elastomeric products of the invention that have been produced therefrom have been optimized particularly with regard to sustainability, with simultaneously very good properties.

The polymer may alternatively have been produced only partly from monomers from biomasses, especially when some of the parent monomers of the polymer are not obtainable via biomasses.

As a result, the process of the invention and the composite materials of the invention that have been produced thereby and elastomeric products of the invention that have been produced therefrom have been optimized with regard to the required flexibility and sustainability, depending on availability of starting materials, with simultaneously very good properties.

As is known to the person skilled in the art, the proportion of the biobased materials, i.e. the proportion derived from renewable raw materials in the polymer, can be determined in accordance with ASTM D6866 (C-14 method).

There follows a description of further particular embodiments of the process of the invention that are notable with regard to the selection of the material of the strength members and are accordingly based on corresponding process steps as component steps in the production of tensile strength members in step a).

In a first advantageous embodiment of the process of the invention, the textile strength member in step a) has filaments containing at least recycled PET, wherein process step a) comprises at least the following individual process steps:
a01) providing at least one product made of PET, wherein the product is especially selected from bottles and clothing and yarn wastes;
a02) mechanically and/or chemically recycling the PET product from step a01);
a03) forming the recycled PET from step a02) to filaments, wherein the filaments are preferably processed, especially spun, to a yarn;
a04) processing the filaments obtained in step a03), preferably in the form of a yarn, to give a strength member, especially a reinforcement cord.

The object underlying the invention is achieved particularly efficiently by the selection of recycled PET, especially of PET recycled from bottles or clothing or yarn wastes.

In advantageous embodiments, a PET yarn which is a “regular PET yarn” is obtained in step a03).

“Regular PET yarn” in the context of the present invention especially means a yarn having a hot shrinkage of not less than 8% and an elongation at 45 N of greater than 0.0056%/den, with linear filament densities of less than 5 den.

In a further advantageous embodiment of the process of the invention, the textile strength member in step a) has filaments containing at least recycled PET, wherein process step a) comprises at least the following individual process steps:
a10) providing PET chips comprising 100% by weight of recycled PET from PET bottles or other PET products, and optionally providing chips of virgin, i.e. mineral oil-based, PET;
a11) pre-crystallization, crystallization and solid-state polymerization of the PET from step a10) to give high-viscosity PET chips having an intrinsic viscosity of 0.85 to 1.15 dl/g;
a12) drying, optionally mixing the chips of recycled PET with chips of virgin PET, giving PET chips comprising 10 to 100% by weight of chips of recycled PET, melting and extruding the PET chips for the yarn spinning, then yarn spinning by means of a spinneret comprising a reheater having a buffer zone for the high-viscosity PET chips from step a11), and stepwise cooling of the unstretched yarn, wherein the water content of the chips after drying is less than 30 ppm, the temperature of the reheater beneath the spinneret is 280 to 350° C. and the length of the buffer zone beneath the reheater during the stepwise cooling is 20 to 100 mm;
a13) oiling, drawing, heat-setting and winding after stepwise cooling in step a12) to obtain a PET yarn composed of filaments consisting wholly or partly of recycled PET, wherein the resultant PET yarn is an HMLS PET yarn having a hot shrinkage of less than 8% and an expansion at 45 N of less than 0.0056%/den in the case of linear filament densities of less than 5 den;
a14) processing the yarn obtained in step a13) to give a reinforcement cord.

The object underlying the invention is achieved particularly efficiently by the selection of recycled HMLS PET yarn.

The abbreviation “HMLS” is familiar to the person skilled in the art and means “high modulus low shrinkage”. An “HMLS yarn” is thus understood to mean a high-modulus low-shrinkage yarn. In the context of the present invention, an HMLS yarn is defined in that, as set out above, it has hot shrinkage of less than 8% and elongation at 45 N of less than 0.0056%/den, with linear filament densities of less than 5 den.

The yarn of HMLS PET preferably has hot shrinkage of 4% to 8%, and elongation at 45 N of 0.002%/den to 0.0056%/den, with linear filament densities of less than 5 den, more preferably 3 to 5 den.

The elastomeric product of the invention is preferably a vehicle tire including the HMLS PET yarn A) in the carcass ply. As a result, flatspot characteristics (=reversible plastic flaking in the ground contact patch on parking) are optimized and extensive sidewall indentations are avoided.

Hot shrinkage of yarns in the context of the present invention is determined by means of the hot shrinkage method to ASTM D885. The test conditions are: temperature 177° C., load 0.05 g/den, duration 10 min.

Elongation at 45 N is determined in the context of the present invention by means of an Instron tensile tester to ASTM D885: Instron 5564 instrument, clamp: C-clamp, 2714-004 with pneumatic activation, load capacity 1 kN (1 kilonewton), test conditions: gauge length 250 mm, cross-head speed 300 mm/minute, pre-tension 0.05 gf/den (gram force per denier), air pressure 0.4 to 0.6 MPa, conditioning of the samples before the test: 24 hours at 24+ (plus/minus) 2° C., 55+5% air humidity.

Intrinsic viscosity is determined in the context of the present invention by means of an Ubbelohde capillary viscometer to ASTM D4603.

Pre-crystallization, crystallization and solid-state polymerization (SSP) in step a11) achieve further polymerization and hence a reduction in the proportion of shorter polymer molecules, which achieves molecular chain growth. This results in elevated intrinsic viscosity. This improves the drawability of the material, with an improvement in the tensile strength and modulus (stiffness) of the yarn as well.

By combining the pre-crystallization and crystallization with the temperature of the reheater beneath the spinneret of 280 to 350° C. and the length of the buffer zone under the reheater during the stepwise cooling of 20 to 100 mm in step a12), it is possible to adjust the crystallization rate in such a way as to choose a high spinning speed and a high tension rate in the spinning process.

Moreover, the frequency of filament and yarn breakage is reduced, which results in a yarn having high tensile strength and high modulus.

Solid-state polymerization (SSP) is a process in which the crude PET chips are placed in a reactor and heated in order to polymerize. This increases molecular chain length and intrinsic viscosity. The intrinsic viscosity of recycled PET chips is 0.55 to 0.75 dl/g.

Solid-state polymerization is also referred to as solid-phase condensation, since the withdrawal of water results in condensation.

The recycled PET in the abovementioned embodiments-from the processes according to steps a01) to a04) and a10) to a14)-in preferred embodiments is based entirely, i.e. to an extent of 100% by weight, on recycled PET. As a result, the process of the invention and the composite materials of the invention that have been produced thereby and elastomeric products of the invention that have been produced therefrom have been optimized particularly with regard to sustainability, with simultaneously very good properties.

In further preferred embodiments, the recycled PET may also be based to an extent of 1% to 90% by weight on recycled PET and to an extent of 10% to 99% by weight on mineral oil-based PET. As a result, the process of the invention and the composite materials of the invention that have been produced thereby and elastomeric products of the invention that have been produced therefrom have been optimized particularly with regard to the balance of sustainability with simultaneously very good properties, where it is simultaneously possible by controlled selection of the proportion of recycled PET to adjust the properties of the products produced as required.

In the case of the process according to steps a01) to a04), in these embodiments, especially in step a03), in the forming to give the filaments and/or in the forming of the filaments to give the yarn, mineral oil-based PET is added in appropriate proportions.

Recycled PET that has especially been produced by mechanical recycling from bottles differs from virgin (nonrecycled) PET by additions such as, in particular, by the content of isophthalic acid (IPA). These additions, especially of IPA, are present, for example and in particular, in PET bottles.

While virgin PET has an isophthalic acid content of 0% by weight, the IPA content in recycled PET may be up to 5% by weight.

More particularly, in the recycled PET used in the context of the present invention, it is, for example and in particular, 1.2% to 5% by weight, more preferably 1.2% to 2.2% by weight.

The weight figures in percent (% by weight) are based here on the PET and hence, in the strength member of the invention, on the unrubberized and unpretreated, i.e. especially undipped, yarn.

Recycled PET that has been obtained by mechanical recycling from yarn wastes has a greater polydispersity index compared to reference yarns that have not been recycled.

In a further advantageous embodiment of the process of the invention, the textile strength member in step a) has filaments containing at least biobased polymer, wherein process step a) comprises at least the following individual process steps:
a21) producing or providing a starting composition comprising starting monomers produced entirely or at least partly from biomass;
a22) polymerizing the starting monomers present in the starting composition to give a biobased polymer;
a23) forming the biobased polymer to filaments, wherein the filaments are preferably processed, especially spun, to a biobased polymer yarn;
a24) processing the filaments obtained in step a23), preferably in the form of a yarn, to give a strength member, especially a reinforcement cord.

In the context of the present invention, what is meant by “produced entirely from biomasses” is that 100% by weight of the starting monomers has been obtained directly in physical form from biomasses.

In the context of the present invention, what is meant by “produced at least partly from biomasses” is that more than 0% by weight of the starting monomers has been obtained directly in physical form from biomasses.

In preferred embodiments, 10% to 100% by weight, more preferably 30% to 100% by weight, of the starting monomers are produced from biomasses. This means that, in these preferred embodiments, the biobased polymer is based to an extent of 10% to 100% by weight, more preferably to an extent of 30% to 100% by weight, on the polymerization of starting monomers produced from biomasses.

More preferably, the biobased polymer is selected from the group consisting of polyethylene terephthalate (PET), nylon-6,6 (PA 6.6), polyamide (PA 5.6), nylon-4,6 (PA 4.6), nylon-4,10 (PA 4.10) and aramid.

PET is based on the polymerization, especially polycondensation, of the starting monomers terephthalic acid and monoethylene glycol (MEG, also ethanediol).

The biobased PET is preferably based to an extent of 30% to 100% by weight on the polymerization of starting monomers produced from biomasses.

In advantageous embodiments, both monomers of the biobased PET are obtained not from mineral oil but from biomasses.

In further advantageous embodiments, at least monoethylene glycol is obtained from biomasses, especially from plant raw materials, for example sugarcane or molasses.

Nylon-6,6 (PA 6.6) is based on polymerization, especially polycondensation, of the starting monomers hexamethylenediamine and adipic acid.

The biobased PA 6.6 is preferably based to an extent of 50% to 100% by weight on the polymerization of starting monomers produced from biomasses.

In advantageous embodiments, both monomers of the biobased PA 6.6 are obtained not from mineral oil but from biomasses.

Nylon-5,6 is based on polymerization, especially polycondensation, of the starting monomers pentamethylenediamine (1,5-diaminopentane) and adipic acid.

In advantageous embodiments, both monomers of the biobased PA 5.6 are obtained not from mineral oil but from biomasses.

In further advantageous embodiments, at least pentamethylenediamine is obtained not from mineral oil but from biomasses.

Nylon-4,6 is based in particular on polymerization, especially polycondensation, of the starting monomers hexamethylenediamine and succinic acid.

In advantageous embodiments, both monomers of the biobased PA 4.6 are obtained not from mineral oil but from biomasses.

In further advantageous embodiments, at least succinic acid is obtained not from mineral oil but from biomasses.

Nylon-4,10 is based on polymerization, especially polycondensation, of the starting monomers tetramethylenediamine and sebacic acid.

In advantageous embodiments, both monomers of the biobased PA 4.10 are obtained not from mineral oil but from biomasses.

In further advantageous embodiments, at least tetramethylenediamine is obtained not from mineral oil but from biomasses.

In further advantageous embodiments, at least sebacic acid is obtained not from mineral oil but from biomasses.

In advantageous embodiments, the biobased polymer is biobased aramid.

In preferred embodiments, the biobased aramid is based to an extent of 50% to 100% by weight on the polymerization, especially polycondensation, of starting monomers produced from biomasses (monomers from biomasses).

In preferred embodiments, the biobased aramid is based entirely, i.e. to an extent of 100% by weight, on the polymerization, especially polycondensation, of monomers from biomasses.

In a further advantageous embodiment of the process of the invention, the textile strength member in step a) has filaments containing at least recycled polymer, wherein process step a) comprises at least the following individual process steps:
a31) providing wastes such as, in particular, used tires, yarn wastes, and wastes from the manufacture of semifinished products from vehicle tires and other industrial rubber articles;
a32) pyrolyzing the wastes from step a31) to obtain a pyrolysis oil containing at least one chemical starting substance;
a33) converting the chemical starting substance to at least one monomer, where the monomer is preferably selected from the group consisting of p-phenylenediamine, tetramethylenediamine, pentamethylenediamine, hexamethylenediamine, decamethylenediamine, terephthalic acid, monoethylene glycol, adipic acid, succinic acid, sebacic acid and polycondensable derivatives of these monomers, and polymerizing the monomer to a recycled polymer;
a34) forming the recycled polymer to filaments, wherein the filaments are preferably processed, especially spun, to a polymer yarn;
a35) processing the filaments obtained in step a34), preferably in the form of a yarn, to give a strength member, especially a reinforcement cord.

“Wastes” in the context of the present invention, in principle, mean any wastes suitable as starting substances for the process steps.

The wastes are preferably used tires, yarn wastes, especially from yarn production, and wastes from the manufacture of semifinished products from vehicle tires and other industrial rubber articles.

Particular preference is given to used tires and yarn wastes.

The monomers mentioned with preference are especially those from which polymers such as polyethylene terephthalate (PET) or nylon-6,6, for example, can be obtained by polycondensation.

What is meant by “polycondensable derivatives of these monomers” is monomers that have a base structure similar to the monomers mentioned and lead to the same target polymers by analogous polycondensation.

In the case of PET as “target polymer”, one monomer is terephthalic acid.

An example of a polycondensable derivative thereof would be methyl terephthalate.

In particular and by way of example, polycondensable derivatives are thus selected from carboxylic esters, preferably alkyl carboxylates, preferably selected from the group consisting of alkyl terephthalates, alkyl adipates, alkyl succinates, alkyl sebacates.

The alkyl radical of all alkyl carboxylates mentioned is, for example and with preference, selected from the group consisting of methyl, ethyl, propyl, butyl, pentyl, hexyl and cyclohexyl, more preferably methyl, ethyl, propyl.

In further preferred embodiments of the invention, the monomer in step a33) is selected from the group consisting of p-phenylenediamine, tetramethylenediamine, pentamethylenediamine, hexamethylenediamine, decamethylenediamine, terephthalic acid, monoethylene glycol, adipic acid, succinic acid and sebacic acid.

In all embodiments described, it is conceivable and preferable that, in the process step of forming the polymers to filaments and/or the filaments to yarns, additional steps are conducted, such as, in particular, the addition of a further polymer, preferably from one of the other described preferred processes for production of textile strength members in step a).

In this way, preference is given to producing textile strength members that have at least two different polymers, preferably in a homogeneous mixture. This means that the process of the invention is optimized particularly with regard to sustainability and, at the same time, by specific selection of the materials, the properties of the composite materials and elastomeric products produced can be adjusted as required.

In particularly advantageous embodiments of the process of the invention, the textile strength member in step a) thus has filaments, wherein the filaments contain at least one material selected from the group consisting of recycled polyethylene terephthalate (rPET), recycled polyethylene naphthalate (rPEN), biobased polyethylene terephthalate (bioPET), recycled PA6.6, biobased PA6.6, biobased PA5.6, biobased PA4.6, biobased PA4.10, biobased aramid.

The crosslinkable rubberization mixture preferably contains at least one constituent selected from the group consisting of biobased fillers, preferably silica produced from rice husk ash, recycled fillers, preferably pyrolysis carbon blacks, biobased polymers, preferably biobased polybutadiene, and wherein the rubberization mixture is preferably essentially free of resorcinol.

In this way, the sustainability and benignity in terms of the environment and health of the process of the invention and of the composite material produced and of the elastomeric product produced are increased further, where the physical properties of the composite material produced and of the elastomeric product produced are simultaneously at a very good level.

Pyrolysis carbon blacks are known to the person skilled in the art, for example from US2010249353 A1, and are obtained by pyrolysis of used tires in the absence of oxygen.

Pyrolysis carbon black differs from industrial carbon black, especially the ASTM carbon blacks such as N660, in properties including a higher ash content and simultaneously lower content of polycyclic aromatic hydrocarbons (PAH).

Industrial carbon blacks have a high proportion of polycyclic aromatic hydrocarbons (PAH). Industrial carbon blacks have a PAH content of greater than 200 mg/kg.

The PAH content of the pyrolysis carbon blacks used in the context of the present invention is preferably less than 50 ppm (mg/kg), more preferably less than 40 ppm, most preferably less than 30 ppm, preferably in turn less than 10 ppm. The lower limit is in the region of 0.1 mg/kg, which constitutes the detection limit for PAH. In principle, the PAH content should be as low as possible.

The PAH content is determined to ASTM D-5186.

The pyrolysis carbon blacks used in the context of the present invention preferably have an ash content of 5% to 30% by weight, more preferably 10% to 30% by weight, most preferably 10% to 20% by weight. In a preferred embodiment of the invention, the ash content is 15% to 20% by weight.

The ash content is based solely on pyrolysis carbon black and is determined by thermogravimetric analysis (TGA) to ASTM D1506 of the pyrolysis carbon black.

“Silica produced from rice husk ash” is also known to those skilled in the art as “rice husk ash silica” (RHAS).

This is silica obtained from the inorganic combustion residues (ash) of rice husks. The ash obtained from rice husks comprises a relatively high silica proportion of more than 80% by weight and is therefore particularly suitable for obtaining silica.

The silica produced from rice husk ash preferably present in the rubberization mixture preferably has a nitrogen surface area (BET surface area) (to DIN ISO 9277 and DIN 66132) of 35 to 400 m²/g, more preferably of 35 to 350 m²/g, even more preferably of 75 to 320 m²/g and even more preferably in turn of 120 to 235 m²/g, and a CTAB surface area (to ASTM D 3765) of 30 to 400 m²/g, more preferably of 30 to 330 m²/g, even more preferably of 70 to 300 m²/g and even more preferably in turn of 110 to 230 m²/g.

What is meant by biobased polymers, preferably biobased polybutadiene, analogously to the above remarks, is that at least one monomer of the polymer of the rubberization mixture is obtained from biomasses.

The rubberization mixture is preferably essentially free of resorcinol.

This is especially and preferably achieved by selection of one or more of the following options:
I) the rubberization mixture is free of reinforcer resins and contains 0 phr of methylene acceptors and methylene donors, which includes freedom of the mixture from resorcinol;
II) the rubberization mixture is free of methylene acceptors and contains 0 phr of methylene acceptors, which includes freedom of the mixture from resorcinol;
III) the rubberization mixture contains a suitable substance as resorcinol substitute in combination with a methylene donor, such as preferably and by way of example at least one novolak resin having alkylurethane units, and an etherified melamine resin, as described, for example, in EP 2 432 810 B1 or WO 2021197648 A1.

The rubberization mixture may otherwise be any suitable rubberization mixture known to the person skilled in the art for ensheathing of strength members, especially textile strength members. The rubberization mixture preferably contains at least one diene rubber, especially if biobased polymer, especially polybutadiene, is not already present in the rubberization mixture.

The presence of at least one diene rubber means that the rubberization mixture is in particular sulfur-vulcanizable. The vulcanizable composite material produced is thus suitable for a multitude of elastomeric products, especially vehicle tires.

The vulcanizable composite materials produced by the process of the invention may be incorporated into blanks, for example into blanks for vehicle tires.

Preference is consequently also given to a process of the invention additionally comprising the step of:

d) producing an unvulcanized blank, especially an unvulcanized vehicle tire blank, comprising the vulcanizable composite material.

The invention additionally relates to a process for producing an elastomeric product, especially a vehicle tire, or a vulcanized composite material, comprising the steps of the process of the invention for producing a vulcanizable composite material, and additionally at least one of the following steps:
e) vulcanizing the vulcanizable composite material to obtain a vulcanized composite material, and/or
f) vulcanizing the unvulcanized blank to obtain an elastomeric product.

The invention also relates to the vulcanizable composite material produced by the process of the invention, to the vulcanized composite material producible therefrom and to the corresponding elastomeric products, respectively resulting in the benefits discussed above.

The invention thus also relates to a vulcanizable composite material for the production of elastomeric products, especially of vehicle tires, preferably produced or producible by the process of the invention for production of a vulcanizable composite material, comprising:
i) at least one textile strength member that has been adhesion-activated with an aqueous dispersion, and
ii) a crosslinkable rubberization mixture that surrounds the textile strength member,
wherein the aqueous dispersion is essentially free of free resorcinol and resorcinol precondensates, especially resorcinol-formaldehyde precondensates, and is free of free formaldehyde and formaldehyde-releasing substances,
wherein the textile strength member has filaments, wherein the filaments contain one or more materials selected from the group consisting of
a1) recycled polymers and a2) biobased polymers, wherein the recycled and biobased polymers are preferably selected from the group consisting of
polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12 and
aramids such as, in particular, m-aramid and p-aramid.

Since the activation of adhesion caused by the aqueous dispersion is a complex coating having a structure that inherently cannot be described precisely, it is necessary to define the textile strength members used in the vulcanizable composite material of the invention via the activation of adhesion that they undergo.

Preference is therefore given to a vulcanizable composite material of the invention wherein the textile strength member is adhesion-activated with the aqueous dispersion on all sections surrounded by the crosslinkable rubberization mixture.

The invention likewise relates to a vulcanized composite material produced by vulcanization of the vulcanizable composite material of the invention, preferably by the process of the invention for production of a vulcanized composite material.

The invention likewise relates to an elastomeric product, especially vehicle tire, comprising a vulcanized composite material of the invention, preferably produced by the process of the invention for production of an elastomeric product.

In the context of the present invention, “vehicle tires” mean pneumatic vehicle tires and all-rubber tires, including tires for industrial and construction site vehicles, truck tires, agricultural tires, car tires and two-wheeler tires.

In further preferred embodiments, the elastomeric product is an industrial rubber article such as, in particular, a conveyor belt, drive belt, other belt, or hose.

Preference is given to an elastomeric product, wherein the elastomeric product is a vehicle tire that has the vulcanized composite material in the carcass ply and the textile strength member preferably has filaments, wherein the filaments contain one or more materials selected from the group consisting of polyesters or polyamides.

Preference is additionally given to an elastomeric product, wherein the elastomeric product is a vehicle tire that has the vulcanized composite material in the jointless bandage and the textile strength member preferably has filaments, wherein the filaments contain one or more materials selected from the group consisting of polyamides, wherein the filaments more preferably contain PA6.6 or a combination of PA6.6 and p-aramid or PET or PA4.6.

Preference is additionally given to an elastomeric product, wherein the elastomeric product is a vehicle tire that has the vulcanized composite material in the bead reinforcer and the textile strength member preferably has filaments, wherein the filaments contain one or more materials selected from the group consisting of polyamides, more preferably PA6.6 and PA6, and polyesters, more preferably PET, and aramids, more preferably p-aramid.

Preference is also given to an elastomeric product, wherein the elastomeric product is a vehicle tire that firstly, in a first configuration, has the vulcanized composite material in the jointless bandage and the textile strength member preferably has filaments, where the filaments contain one or more materials selected from the group consisting of polyamides, where the filaments more preferably contain PA6.6, and secondly has the vulcanized composite material, in a further configuration, in the carcass ply and the textile strength member preferably has filaments, where the filaments contain one or more materials selected from the group consisting of polyesters, where the filaments more preferably contain PET or PEN.

Preference is also given to an elastomeric product, wherein the elastomeric product is a vehicle tire that firstly, in a first configuration, has the vulcanized composite material in the belt ply and the textile strength member preferably has filaments, where the filaments contain one or more materials selected from the group consisting of polyamides and aramids, where the filaments more preferably contain PA6.6 and/or PA6 and/or p-aramid, and secondly has the vulcanized composite material, in a further configuration, in the carcass ply and the textile strength member preferably has filaments, where the filaments contain one or more materials selected from the group consisting of polyamides, where the filaments more preferably contain PA6.6 and/or PA6.

Preference is also given to an elastomeric product, wherein the elastomeric product is a vehicle tire having at least one reinforcement cord, preferably at least one x2 and/or at least one x3 reinforcement cord, where at least one first yarn of the reinforcement cord has filaments of biobased nylon and at least one further yarn has filaments of biobased aramid. For example with preference, the vehicle tire has the reinforcement cord in the jointless bandage.

In advantageous developments of the invention, the elastomeric product contains recycled steel in the form of strength members. For example, the elastomeric product here is a vehicle tire containing, in a component, for example in at least one belt ply and/or in at least one bead core and/or at least in the carcass ply, recycled steel in the form of strength members.

“Recycled steel” in the context of the present invention means steel that has been produced entirely, i.e. to an extent of 100% by weight, or at least partly, i.e. to an extent of 1% to 99.99% by weight, preferably 50% to 99.99% by weight, by a method of recycling steel (used steel).

In this way, the elastomeric product has been further optimized with regard to sustainability.

The description is further elucidated hereinafter by some illustrative and particularly advantageous configurations of the process of the invention or of the products of the invention obtained therefrom.

### EXAMPLE 1

First of all, in step a), textile strength members are produced from recycled HMLS PET yarn. For this purpose, starting materials provided in step a10) are PET chips comprising 100% by weight of recycled PET from PET bottles or other PET products, and the process is conducted according to steps a11) to a14), including the solid-state polymerization as described above.

The raw PET chips, in step a11), are pre-crystallized at a temperature of 150 to 180° C. for 0.5 to 1.5 hours and then crystallized at a temperature of 200 to 230° C. for 4 to 6 hours and finally left to react in an SSP reactor at a wall temperature of 200 to 220° C. for 30 to 35 hours.

The entire system of apparatuses is operated in a nitrogen atmosphere, where the oxygen content of the nitrogen is kept at 30 to 70 ppm and the dew point is preferably lower than−70° C. (lower than minus 70° C.).

The chips, in step a12), are processed to an unstretched yarn and then, in step a13), processed to an HMLS yarn, where the yarn has a hot shrinkage of 2.3% and an elongation at 45 N of 0.0008%/den at linear filament densities of less than 5 den.

The yarn is produced with a linear density of 1667 dtex, and 2 yarns in each case are end-twisted with one another to give an x2 cord.

The cords are then pretreated with a preliminary dip. The preliminary dip has the following composition: 95.26% by weight (percent by weight) of water, 0.90% by weight of Denacol EX313 (an epoxy compound) and 3.84% by weight of Grilbond IL-6 (a polyisocyanate compound). Subsequently, the pre-dipped cords are heat-treated at 210 to 250° C.

Thereafter, in step b), the cords are treated with an aqueous dispersion for activation of adhesion, where the aqueous dispersion contains neither free resorcinol or resorcinol precondensates nor free formaldehyde or formaldehyde-releasing substances, and otherwise contains the following constituents: 47.3% by weight of water, 35.67% by weight of VP latex (copolymer of butadiene, styrene and 2-vinylpyridine, contains about 15% by weight of vinylpyridine bound in the polymer, aqueous dispersion, 41% by weight), 6.3% by weight of SBR latex (styrene-butadiene copolymer, aqueous dispersion, 41% by weight), 4.33% by weight of protected isocyanate (Grilbond IL-6: caprolactam-protected 4,4′-methylene diphenyl diisocyanate, aqueous dispersion, 60% by weight (EMS-GRILTECH)), 0.13% by weight of ammonia (ammonium hydroxide, aqueous solution, 25% by weight), 0.34% by weight of polymer having carboxylic acid-functional groups (Acrodur 950L: polyacrylate, aqueous solution, 50% by weight in water (BASF)); 1.54% by weight of epoxy compound (Denacol EX313: glycerol-based polyglycidyl ether (Nagase Chemtex); 4.4% by weight of wax (Hydrowax-Q: aqueous paraffin dispersion, 54% by weight (Sasol). Subsequently, the dipped cords are heat-treated at 170 to 250° C.

Subsequently, the adhesion-activated textile strength member is fully embedded into a crosslinkable rubberization mixture. The crosslinkable rubberization mixture contains, inter alia, 100 phr of diene rubbers, including at least 50 phr of polyisoprene, and 30 phr of pyrolysis carbon black.

As part of a customary vulcanization system, the crosslinkable rubberization mixture additionally comprises 2.4 phr of sulfur and at least one novolak resin having alkylurethane units, and an etherified melamine resin and additionally customary further constituents.

The unit “phr” (parts per hundred parts of rubber by weight) used in the context of the present invention is the standard unit of quantity for mixture recipes in the rubber industry. The dosage of the parts by weight of the individual substances is always based here on 100 parts by weight of the total mass of all rubbers present in the mixture, which accordingly adds up to 100.

The vulcanizable composite material produced as described above is assembled as carcass ply together with other components to give an unvulcanized car tire blank. The unvulcanized car tire blank is then used to obtain, by vulcanization under customary conditions, a vehicle tire comprising the vulcanized composite material in the carcass ply.

The illustrative car tire thus obtained is a particularly favorable embodiment of a product of the invention in which the advantages of the present invention are manifested to a particularly significant degree. The car tire is produced in a sustainable manner particularly benign to health and the environment, and is of particularly sustainable composition, being simultaneously notable for optimal service life in traveling operation.

### EXAMPLE 2

In a further example (example 2), in step a), tensile strength members are produced by means of component steps a21) to a24), where the textile strength members contain filaments made from 100% by weight of biobased PET. For this purpose, the two monomers of the PET are produced from biomasses and then formed to filaments. The filaments are used to produce biobased PET yarns having a linear density of 1500 den, which are then end-twisted to give an x2 cord; see example 1 above.

Otherwise, the process of the invention is executed as detailed for example 1.

The illustrative car tire obtained according to example 2 is also a particularly favorable embodiment of a product of the invention in which the advantages of the present invention are manifested to a particularly significant degree.

### EXAMPLE 3

In a further example (example 3), in step a), tensile strength members are produced by means of component steps a21) to a24), where the textile strength members contain filaments made from PET which is biobased to an extent of 32.2% by weight. For this purpose, the monoethylene glycol (MEG) monomer of the PET is produced from biomasses and then polymerized together with the terephthalic acid monomer from mineral oil-based physical sources and formed to filaments. The filaments are used to produce biobased PET yarns having a linear density of 1500 den, which are then end-twisted to give an x2 cord; see example 1 above.

Otherwise, the process of the invention is executed as detailed for example 1. The illustrative car tire obtained according to example 3 is also a particularly favorable embodiment of a product of the invention in which the advantages of the present invention are manifested to a particularly significant degree.

1. A process for producing a vulcanizable composite material, comprising the steps of:
a) producing or providing a textile strength member,
b) treating the textile strength member with an aqueous dispersion for adhesive activation of the textile strength member and to obtain an adhesion-activated textile strength member, and
c) introducing the adhesion-activated textile strength member into a crosslinkable rubberization mixture to obtain the vulcanizable composite material, wherein the aqueous dispersion is essentially free of free resorcinol and resorcinol precondensates, especially resorcinol-formaldehyde precondensates, and is free of free formaldehyde and formaldehyde-releasing substances,
wherein the textile strength member in step a) has filaments, wherein the filaments contain one or more materials selected from the group consisting of
a1) recycled polymers and a2) biobased polymers, wherein the recycled and biobased polymers are preferably selected from the group consisting of
polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12 and aramids such as, in particular, m-aramid and p-aramid.

2. The process as claimed in claim 1, wherein the aqueous dispersion comprises:
(x1) at least one rubber latex, preferably in a proportion by mass based on the dry weight of the aqueous dispersion of 4% to 60%, and
(x2) at least one protected isocyanate, preferably in a proportion by mass based on the dry weight of the aqueous dispersion of 0.1% to 10%.

3. The process as claimed in either of claims 1 and 2, wherein the aqueous dispersion comprises:
(y1) at least one compound containing an epoxy group, preferably in a proportion by mass based on the dry weight of the aqueous dispersion of up to 6%, and/or
(y2) at least one polymer having carboxylic acid-functional groups, preferably in a proportion by mass based on the dry weight of the aqueous dispersion of up to 15%.

4. The process as claimed in any of claims 1 to 3, wherein the aqueous dispersion comprises one of the following components:
(z1) at least one filler, preferably in a proportion by mass based on the dry weight of the aqueous dispersion of 0.02% to 20%, preferably with the proviso that the aqueous dispersion does not include any polymer having carboxylic acid-functional groups, or
(z2) at least one polyisoprene rubber latex, preferably in a proportion by mass based on the dry weight of the aqueous dispersion of 1% to 20%, preferably with the proviso that the aqueous dispersion includes at least one rubber latex which is not a polyisoprene rubber latex, or
(z3) at least one wax, preferably in a proportion by mass based on the dry weight of the aqueous dispersion of 0.3% to 30%.

5. The process as claimed in any of claims 1 to 4, wherein the textile strength member in step a) has filaments containing at least recycled PET, wherein process step
a) comprises at least the following individual process steps:
a01) providing at least one product made of PET, wherein the product is especially selected from bottles and clothing and yarn wastes;
a02) mechanically and/or chemically recycling the PET product from step a01);
a03) forming the recycled PET from step a02) to filaments, wherein the filaments are preferably processed, especially spun, to a yarn;
a04) processing the filaments obtained in step a03), preferably in the form of a yarn, to give a strength member, especially a reinforcement cord.

6. The process as claimed in any of the preceding claims, wherein the textile strength member in step a) has filaments containing at least recycled PET,
wherein process step a) comprises at least the following individual process steps:
a10) providing PET chips comprising 100% by weight of recycled PET from PET bottles or other PET products, and optionally providing chips of virgin PET;
a11) pre-crystallization, crystallization and solid-state polymerization of the PET from step a10) to give high-viscosity PET chips having an intrinsic viscosity of 0.85 to 1.15 dl/g;
a12) drying, optionally mixing the chips of recycled PET with chips of virgin PET, giving PET chips comprising 10 to 100% by weight of chips of recycled PET, melting and extruding the PET chips for the yarn spinning, then yarn spinning by means of a spinneret comprising a reheater having a buffer zone for the high-viscosity PET chips from step a11), and stepwise cooling of the unstretched yarn, wherein the water content of the chips after drying is less than 30 ppm, the temperature of the reheater beneath the spinneret is 280 to 350° C. and the length of the buffer zone beneath the reheater during the stepwise cooling is 20 to 100 mm;
a13) oiling, drawing, heat-setting and winding after stepwise cooling in step a12) to obtain a PET yarn composed of filaments consisting wholly or partly of recycled PET, wherein the resultant PET yarn is an HMLS PET yarn having a hot shrinkage of less than 8% and an expansion at 45 N of less than 0.0056%/den in the case of linear filament densities of less than 5 den;
a14) processing the yarn obtained in step a13) to give a reinforcement cord.

7. The process as claimed in any of the preceding claims, wherein the textile strength member in step a) has filaments containing at least biobased polymer, wherein process step a) comprises at least the following individual process steps:
a21) producing or providing a starting composition comprising starting monomers produced entirely or at least partly from biomass;
a22) polymerizing the starting monomers present in the starting composition to give a biobased polymer;
a23) forming the biobased polymer to filaments, wherein the filaments are preferably processed, especially spun, to a biobased polymer yarn;
a24) processing the filaments obtained in step a23), preferably in the form of a yarn, to give a strength member, especially a reinforcement cord.

8. The process as claimed in any of the preceding claims, wherein the textile strength member in step a) has filaments containing at least recycled polymer, wherein process step a) comprises at least the following individual process steps:
a31) providing wastes such as, in particular, used tires, yarn wastes, and wastes from the manufacture of semifinished products from vehicle tires and other industrial rubber articles;
a32) pyrolyzing the wastes from step a31) to obtain a pyrolysis oil containing at least one chemical starting substance;
a33) converting the chemical starting substance to at least one monomer and polymerizing the monomer to a recycled polymer;
a34) forming the recycled polymer to filaments, wherein the filaments are preferably processed, especially spun, to a polymer yarn;
a35) processing the filaments obtained in step a34), preferably in the form of a yarn, to give a strength member, especially a reinforcement cord.

9. The process as claimed in any of the preceding claims, wherein the textile strength member in step a) has filaments, wherein the filaments contain at least one material selected from the group consisting of recycled polyethylene terephthalate (rPET), recycled polyethylene naphthalate (rPEN), biobased polyethylene terephthalate (bioPET), recycled PA6.6, biobased PA6.6, biobased PA5.6, biobased PA4.6, biobased PA4.10, biobased aramid.

10. The process as claimed in any of the preceding claims, wherein the crosslinkable rubberization mixture contains at least one constituent selected from the group consisting of biobased fillers, preferably silica produced from rice husk ash, recycled fillers, preferably pyrolysis carbon blacks, biobased polymers, preferably biobased polybutadiene, and wherein the rubberization mixture is preferably essentially free of resorcinol.

11. The process as claimed in any of the preceding claims, additionally comprising the step of:
d) producing an unvulcanized blank, especially an unvulcanized vehicle tire blank, comprising the vulcanizable composite material.

12. A process for producing an elastomeric product, especially a vehicle tire, or a vulcanized composite material, comprising the steps of the process as claimed in any of claims 1 to 11, and additionally at least one of the following steps:
e) vulcanizing the vulcanizable composite material to obtain a vulcanized composite material, and/or
f) vulcanizing the unvulcanized blank to obtain an elastomeric product.

13. A vulcanizable composite material for the production of elastomeric products, especially of vehicle tires, comprising:
i) at least one textile strength member that has been adhesion-activated with an aqueous dispersion, and
ii) a crosslinkable rubberization mixture that surrounds the textile strength member,
wherein the aqueous dispersion is essentially free of free resorcinol and resorcinol precondensates, especially resorcinol-formaldehyde precondensates, and is free of free formaldehyde and formaldehyde-releasing substances,
wherein the textile strength member has filaments, wherein the filaments contain one or more materials selected from the group consisting of
a1) recycled polymers and a2) biobased polymers, wherein the recycled and biobased polymers are preferably selected from the group consisting of
polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12 and
aramids such as, in particular, m-aramid and p-aramid.

14. A vulcanized composite material produced by vulcanization of the vulcanizable composite material as claimed in claim 13.

15. An elastomeric product, especially vehicle tire, comprising a vulcanized composite material as claimed in claim 14.

16. The elastomeric product as claimed in claim 15, wherein the elastomeric product is a vehicle tire that has the vulcanized composite material in the carcass ply and the textile strength member preferably has filaments, wherein the filaments contain one or more materials selected from the group consisting of polyesters.

17. The elastomeric product as claimed in claim 15 or 16, wherein the elastomeric product is a vehicle tire that has the vulcanized composite material in the jointless bandage and the textile strength member preferably has filaments, wherein the filaments contain one or more materials selected from the group consisting of polyamides, wherein the filaments more preferably contain PA6.6.

18. A process for producing a vulcanizable composite material, comprising the steps of:
a) producing or providing a textile strength member,
b) treating the textile strength member with an aqueous dispersion for adhesive activation of the textile strength member and to obtain an adhesion-activated textile strength member, and
c) introducing the adhesion-activated textile strength member into a crosslinkable rubberization mixture to obtain the vulcanizable composite material,
wherein the aqueous dispersion is essentially free of free resorcinol and resorcinol precondensates, and is free of free formaldehyde and formaldehyde-releasing substances,
wherein the textile strength member in step a) has filaments, wherein the filaments contain one or more materials selected from the group consisting of
a1) recycled polymers and a2) biobased polymers.

19. The process of claim 18, wherein the resorcinol precondensates are resorcinol-formaldehyde precondensates.

20. The process of claim 18, wherein, the recycled and biobased polymers are selected from the group consisting of polyesters, polyamides and aramids.

21. The process of claim 20, wherein,
the polyesters are selected from the group consisting of: polyethylene terephthalate (PET) and polyethylene naphthalate (PEN),
the polyamides are selected from the group consisting of: PA6.6, PA5.6, PA4.6, PA4.10, PA6, PA6.12, PA10.10, PA12.12, and
the aramids are selected from the group consisting of: m-aramid and p-aramid.

22. The process as claimed in claim 18, wherein the aqueous dispersion comprises:
(x1) at least one rubber latex, preferably in a proportion by mass based on the dry weight of the aqueous dispersion of 4% to 60%, and
(x2) at least one protected isocyanate, preferably in a proportion by mass based on the dry weight of the aqueous dispersion of 0.1% to 10%.

23. The process as claimed in claim 18, wherein the aqueous dispersion comprises:
(y1) at least one compound containing an epoxy group, preferably in a proportion by mass based on the dry weight of the aqueous dispersion of up to 6%, and/or
(y2) at least one polymer having carboxylic acid-functional groups, preferably in a proportion by mass based on the dry weight of the aqueous dispersion of up to 15%.

24. The process as claimed in claim 18, wherein the aqueous dispersion comprises one of the following components:
(z1) at least one filler, preferably in a proportion by mass based on the dry weight of the aqueous dispersion of 0.02% to 20%, preferably with the proviso that the aqueous dispersion does not include any polymer having carboxylic acid-functional groups, or
(z2) at least one polyisoprene rubber latex, preferably in a proportion by mass based on the dry weight of the aqueous dispersion of 1% to 20%, preferably with the proviso that the aqueous dispersion includes at least one rubber latex which is not a polyisoprene rubber latex, or
(z3) at least one wax, preferably in a proportion by mass based on the dry weight of the aqueous dispersion of 0.3% to 30%.

25. The process as claimed in claim 18, wherein the textile strength member in step a) has filaments containing at least recycled PET, wherein process step a) comprises at least the following individual process steps:
a01) providing at least one product made of PET, wherein the product is especially selected from bottles and clothing and yarn wastes;
a02) mechanically and/or chemically recycling the PET product from step a01);
a03) forming the recycled PET from step a02) to filaments, wherein the filaments are preferably processed, especially spun, to a yarn;
a04) processing the filaments obtained in step a03), preferably in the form of a yarn, to give a strength member, especially a reinforcement cord.

26. The process as claimed in claim 18, wherein the textile strength member in step a) has filaments containing at least recycled PET,
wherein process step a) comprises at least the following individual process steps:
a10) providing PET chips comprising 100% by weight of recycled PET from PET bottles or other PET products, and optionally providing chips of virgin PET;
a11) pre-crystallization, crystallization and solid-state polymerization of the PET from step a10) to give high-viscosity PET chips having an intrinsic viscosity of 0.85 to 1.15 dl/g;
a12) drying, optionally mixing the chips of recycled PET with chips of virgin PET, giving PET chips comprising 10 to 100% by weight of chips of recycled PET, melting and extruding the PET chips for the yarn spinning, then yarn spinning by means of a spinneret comprising a reheater having a buffer zone for the high-viscosity PET chips from step a11), and stepwise cooling of the unstretched yarn, wherein the water content of the chips after drying is less than 30 ppm, the temperature of the reheater beneath the spinneret is 280 to 350° C. and the length of the buffer zone beneath the reheater during the stepwise cooling is 20 to 100 mm;
a13) oiling, drawing, heat-setting and winding after stepwise cooling in step a12) to obtain a PET yarn composed of filaments consisting wholly or partly of recycled PET, wherein the resultant PET yarn is an HMLS PET yarn having a hot shrinkage of less than 8% and an expansion at 45 N of less than 0.0056%/den in the case of linear filament densities of less than 5 den;
a14) processing the yarn obtained in step a13) to give a reinforcement cord.

27. The process as claimed in claim 18, wherein the textile strength member in step a) has filaments containing at least biobased polymer, wherein process step a) comprises at least the following individual process steps:
a21) producing or providing a starting composition comprising starting monomers produced entirely or at least partly from biomass;
a22) polymerizing the starting monomers present in the starting composition to give a biobased polymer;
a23) forming the biobased polymer to filaments, wherein the filaments are preferably processed, especially spun, to a biobased polymer yarn;
a24) processing the filaments obtained in step a23), preferably in the form of a yarn, to give a strength member, especially a reinforcement cord.

28. The process as claimed in claim 18, wherein the textile strength member in step a) has filaments containing at least recycled polymer, wherein process step a) comprises at least the following individual process steps:
a31) providing wastes such as, in particular, used tires, yarn wastes, and wastes from the manufacture of semifinished products from vehicle tires and other industrial rubber articles;
a32) pyrolyzing the wastes from step a31) to obtain a pyrolysis oil containing at least one chemical starting substance;
a33) converting the chemical starting substance to at least one monomer and polymerizing the monomer to a recycled polymer;
a34) forming the recycled polymer to filaments, wherein the filaments are preferably processed, especially spun, to a polymer yarn;
a35) processing the filaments obtained in step a34), preferably in the form of a yarn, to give a strength member, especially a reinforcement cord.

29. The process as claimed in claim 18, wherein the textile strength member in step a) has filaments, wherein the filaments contain at least one material selected from the group consisting of recycled polyethylene terephthalate (rPET), recycled polyethylene naphthalate (rPEN), biobased polyethylene terephthalate (bioPET), recycled PA6.6, biobased PA6.6, biobased PA5.6, biobased PA4.6, biobased PA4.10, biobased aramid.

30. The process as claimed in, wherein the crosslinkable rubberization mixture contains at least one constituent selected from the group consisting of biobased fillers, preferably silica produced from rice husk ash, recycled fillers, preferably pyrolysis carbon blacks, biobased polymers, preferably biobased polybutadiene, and wherein the rubberization mixture is preferably essentially free of resorcinol.

31. The process as claimed in claim 18, additionally comprising the step of:
d) producing an unvulcanized blank, especially an unvulcanized vehicle tire blank, comprising the vulcanizable composite material.

32. A process for producing an elastomeric product, especially a vehicle tire, or a vulcanized composite material, comprising the steps of the process as claimed in claim 18, and additionally at least one of the following steps:
e) vulcanizing the vulcanizable composite material to obtain a vulcanized composite material, and/or
f) vulcanizing the unvulcanized blank to obtain an elastomeric product.

33. A vulcanizable composite material for the production of elastomeric products, comprising:
i) at least one textile strength member that has been adhesion-activated with an aqueous dispersion, and
ii) a crosslinkable rubberization mixture that surrounds the textile strength member, wherein the aqueous dispersion is essentially free of free resorcinol and resorcinol precondensates, especially resorcinol-formaldehyde precondensates, and is free of free formaldehyde and formaldehyde-releasing substances,
wherein the textile strength member has filaments, wherein the filaments contain one or more materials selected from the group consisting of
a1) recycled polymers and a2) biobased polymers, wherein the recycled and biobased polymers are selected from the group consisting of
polyesters selected from the group consisting of polyethylene terephthalate (PET) and polyethylene naphthalate (PEN),
polyamides selected from the group consisting of PA6.6, PA5.6, PA4.6, PA4.10, PA6, PA6.12, PA10.10, PA12.12 and
aramids selected from the group consisting of m-aramid and p-aramid.

34. A vulcanized composite material produced by vulcanization of the vulcanizable composite material as claimed in claim 33.

35. An elastomeric product, especially vehicle tire, comprising a vulcanized composite material as claimed in claim 34.

36. The elastomeric product as claimed in claim 35, wherein the elastomeric product is a vehicle tire that has the vulcanized composite material in the carcass ply and the textile strength member preferably has filaments, wherein the filaments contain one or more materials selected from the group consisting of polyesters.

37. The elastomeric product as claimed in claim 35, wherein the elastomeric product is a vehicle tire that has the vulcanized composite material in the jointless bandage and the textile strength member preferably has filaments, wherein the filaments contain one or more materials selected from the group consisting of polyamides, wherein the filaments more preferably contain PA6.6.
